(19) United States
(12) Patent Application Publication
(10) Pub. No.: US 2006/0161787 A1
(43) Pub. Date: Jul. 20, 2006

(54) Authentication key and apparatus, method, and computer program for authentication

(75) Inventor: Shunichi Kikuchi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/117,751

(22) Filed: Apr. 29, 2005

(30) Foreign Application Priority Data
Jan. 19, 2005 (JP) 2005-011103

(51) Int. Cl. H04K 1/00

(52) U.S. Cl. 713/186

(57) ABSTRACT

An article that is worn or carried by a living being includes an authentication key for identifying the living being or acquiring information about the living being. The authentication key is formed on a surface of the article by processing the article. An authenticating apparatus performs authentication whether an authority to make access to information is present, and includes an authentication key information reading unit and authenticating unit. The authentication key information reading unit reads authentication key information stored in the authentication key. The authenticating unit performs the authentication to check whether an authority to make access to the information about the living being is present based on the read authentication key information.

### BACKGROUND OF THE INVENTION

1) Field of the Invention

The present invention relates to an authentication key from which authentication key information is read which authenticates whether one has authority to make access to information on an article. The present invention also relates to an apparatus, a method, and a computer program for authentication.

2) Description of the Related Art

A technology involving attaching a tag to every article and recognizing the article by the tag has been developed. More particularly, the tag has a resonant element that resonates in a predetermined frequency in an alternating magnetic field. With tags having different resonant frequencies, the respective articles can be recognized.

For example, Japanese Patent Application Laid-Open Publication No. H08-249430 discloses a multi-bit magnetic high frequency tag that includes an array of thin cantilever beams having different lengths. The tag is formed by etching and is coated with a magnetic material.

More specifically, the cantilever beams of the multi-bit magnetic high frequency tag vibrate in respective resonant frequencies when a high frequency magnetic field is applied, and magnetic fields or currents generated by vibrating cantilever beams are detected. The detected magnetic fields or currents are converted into predetermined codes for identifying the articles.

However, in the conventional technology, the tags are attached to the articles. When the tags are removed from the articles, this mechanism does not work. It is not unusual that the tags are removed from the articles. Moreover, if the tags contain important information, there is a risk that the important information is read by persons.

Since writing and reading important information, for example, information on individual, in and from tags is increasingly desired, the above-mentioned conventional technology finds only limited application.

### SUMMARY OF THE INVENTION

It is an object of the present invention to at least solve the problems in the conventional technology.

An article according to one aspect of the present invention, which is worn or carried by a living being, includes an authentication key for identifying the living being or acquiring information about the living being, wherein the authentication key is formed on a surface of the article by processing the article.

An authenticating apparatus according to another aspect of the present invention, which is for performing authentication whether an authority to make access to information is present, includes an authentication key information reading unit that reads authentication key information stored in an authentication key, wherein the authentication key is formed on a surface of an article worn or carried by a living being by processing the article and contains information for identifying the living being or information about the living being, and wherein the authentication key information indicates whether an authority to make access to the information about the living being is present; and an authenticating unit that performs authentication whether an authority to make access to the information about the living being contained in the information key is present based on the authentication key information read by the authentication key information reading unit.

A method according to still another aspect of the present invention, which is for performing authentication whether an authority to make access to information is present, includes reading authentication key information stored in an authentication key, wherein the authentication key is formed on a surface of an article worn or carried by a living being by processing the article and contains information for identifying the living being or information about the living being, and wherein the authentication key information indicates whether an authority to make access to the information about the living being is present; and performing authentication to check whether an authority to make access to the information about the living being contained in the information key is present based on the read authentication key information.

A computer-readable recording medium according to yet another aspect of the present invention stores therein a computer program that implements the above method on a computer.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a schematic for explaining an example of an authentication key according to the present invention;

FIG. 2 is a schematic for explaining another example of the authentication key;

FIG. 3 is a functional block diagram of an authentication system according to a first embodiment of the present invention;

FIG. 4 is a flowchart of a process procedure of authentication according to the first embodiment;

FIG. 5 is a functional block diagram of an authentication system according to a second embodiment of the present invention;

FIG. 6 is a flowchart of a process procedure of authentication according to the second embodiment;

FIG. 7 is a schematic for explaining an idea of lacking article detection to determine whether any article is lacking;

FIG. 8 is a functional block diagram of an authentication system according to a third embodiment of the present invention;

FIG. 9 is a flowchart of a process procedure of authentication according to the third embodiment; and

FIG. 10 is a block diagram of a hardware construction of a computer that serves as an authenticating apparatus in the authentication system shown in FIGS. 3, 5 or 8.

### DETAILED DESCRIPTION

Exemplary embodiments of the present invention are explained in detail below, with reference to the accompanying drawings.

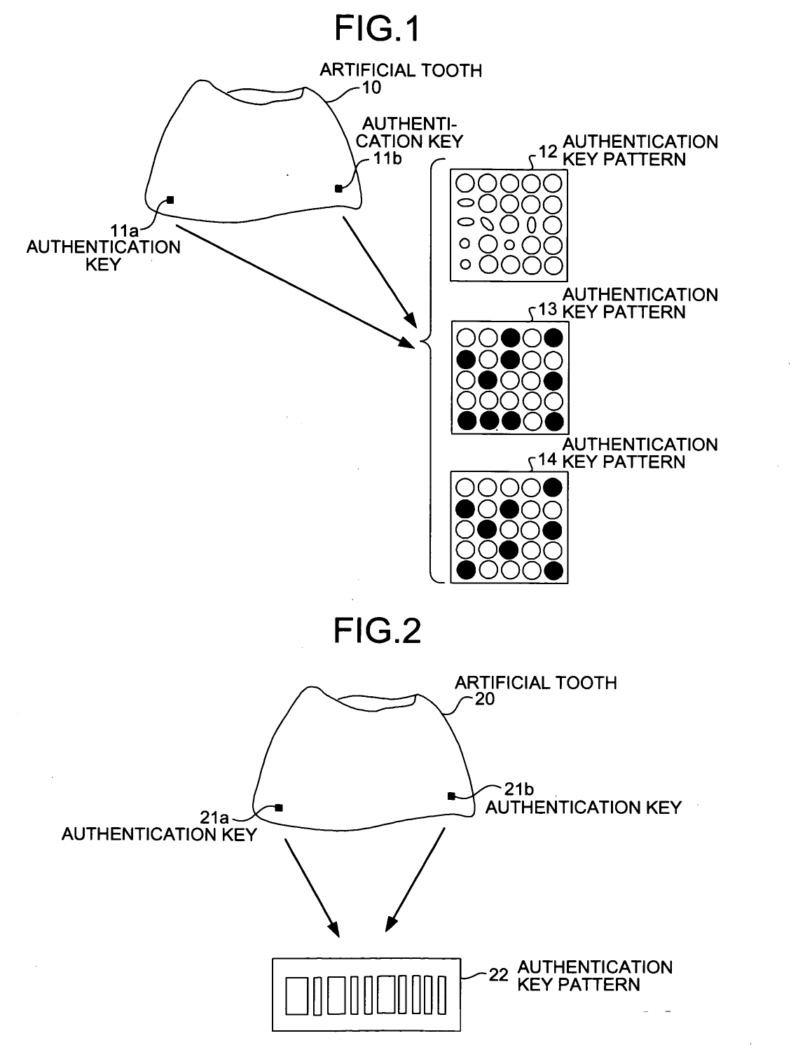

First, the idea of authentication process according to a first embodiment is explained. FIG. 1 is a schematic for explaining an example of an authentication key according to the present invention. As shown in FIG. 1, authentication keys 11a and 11b formed in an artificial tooth 10. Specifically, the authentication keys 11a and 11b are fine depressions and protrusions on the surface of the artificial tooth 10. The fine depressions and protrusions are formed by processing the artificial tooth 10. The authentication keys 11a and 11b are used to perform authentication of a person who is wearing the artificial tooth 10.

Teeth, including artificial teeth, are susceptible to wear. If an authentication key is provided on the tooth, it may get destroyed with time. Therefore, two authentication keys 11a and 11b are provided to ensure that authentication can be performed without fail. It is needless to say that three or more authentication keys will improve the reliability.

The authentication keys can be detected by various methods. For example, the authentication keys can be detected from images of the authentication keys 11a and 11b. The images can be acquired using a camera such as the Charge Coupled Device (CCD) camera or the Complementary Metal-Oxide Semiconductor (CMOS) camera. The images can be obtained using ultrasonic waves or electromagnetic waves, such as laser beams or infrared rays. In this case, the ultrasonic waves or electromagnetic waves are irradiated on the artificial tooth 10 and an image is formed based on intensities of the reflected wave.

When the camera is used, it is preferable to form an authentication key pattern 12 as the authentication keys 11a and 11b. When the ultrasonic wave is used, it is preferable to form an authentication key pattern 13 as the authentication keys 11a and 11b. When the electromagnetic wave is used, it is preferable to form an authentication key pattern 14.

The authentication key pattern 12 has a plurality of depressions and protrusions with different sizes and shapes. Moreover, a database that stores a conversion table is prepared beforehand. The conversion table can be used to convert various depressions and protrusions with different sizes and shapes into characters or numerical symbols. An image of the authentication key pattern 12 is acquired and the image is converted into characters or numerical symbols or both using the conversion table to obtain the authentication information.

The authentication key pattern 13 has a plurality of depressions and protrusions with different depths. Moreover, a database that stores a conversion table is prepared beforehand. The conversion table is used to convert intensities of the reflected waves into characters or numerical symbols. The authentication key information is acquired by converting the intensities of the reflected waves into characters or numerical symbols using the conversion table. The authentication key information can be acquired more reliably by detecting the intensities of the reflected waves using at least two ultrasonic waves with different frequencies.

The authentication key pattern 14 has two types of depressions: depressions with multi-planer surfaces and depressions with flat bottoms. Moreover, a database that stores a conversion table to convert intensities of waves reflected when electromagnetic waves are irradiated to these depressions into characters or numerical symbols is prepared beforehand. The authentication information is acquired by converting the intensities of the reflected waves into the characters or numerical symbols using the conversion table.

The authentication keys 11a and 11b can have different patterns. For example, the authentication keys 11a and 11b can be formed in the form of bar codes as shown in FIG. 2. Authentication keys 21a and 21b are formed on the surface of an artificial tooth 20. The authentication keys 21a and 21b have vertical stripe patterns that resemble bar codes. The vertical stripe portions may be either depressions or protrusions.

The vertical stripes are photographed, for example, with a camera and the patterns acquired are converted into characters or numerical symbols in the same manner as in the processing conducted by a general bar code reader to acquire the authentication key information.

In this manner, if the authentication keys are formed on the surfaces of the artificial teeth, and if the tooth is worn by a person, the person can be authenticated; moreover, the risk that an unauthorized person accesses the important information can be eliminated.

The authentication key can be formed not only on the artificial teeth, but also on the surface of articles that are attached to the human body. For example, the authentication key can be formed on artificial hair.

One approach is to attach a radio frequency identification (RFID) tag to artificial teeth or artificial hair. The RFID tag performs communication using electromagnetic waves. However, there is a problem with the RFID tags. When the person passes near a reader/writer, which reads the information from the RFID tag, the information in the RFID tag can be read easily. Therefore, the present invention does not use the RFID tag for storing therein and acquiring therefrom the authentication key information.

The authentication keys can be formed on various items. For example, the authentication keys can be formed on goods for pets. The authentication keys can be formed on valuable goods, such as watches having embedded with precious stones or precious metals, worn by persons. When forming the authentication key on the valuable goods, if fine processing is performed in the engraved mark or near the engraved mark, the authentication key can be formed without spoiling the values of the valuable goods.

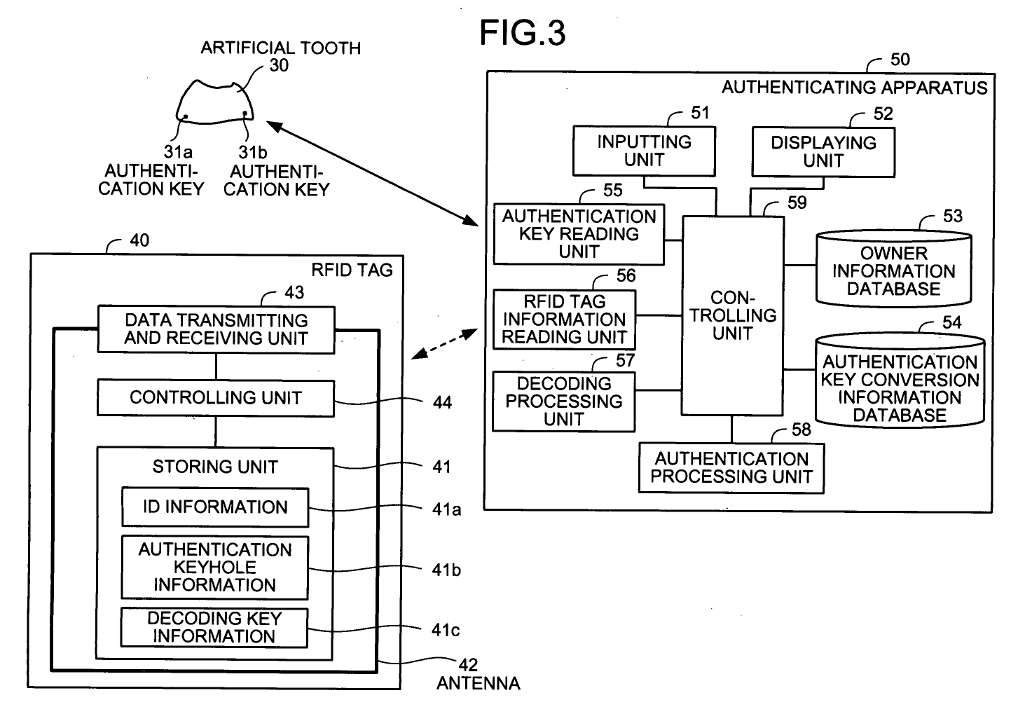

FIG. 3 is a functional block diagram of the authentication system according to the first embodiment. An exemplary case in which information on the authentication key is acquired by taking a picture of the authentication key is explained as the first embodiment.

The authentication system includes an artificial tooth 30, an RFID tag 40, and an authenticating apparatus 50. The artificial tooth 30 has authentication keys 31a and 31b.

The information represented by the authentication keys 31a and 31b is coded form. A decoding key that decodes the coded information is stored in the RFID tag 40.

The RFID tag 40 stores, among other information, authentication keyhole information that is compared with the authentication key information acquired from the authentication keys 31a and 31b. The RFID tag 40 is attached to a plastic card or the like so that it is easy for the users to carry it.

The RFID tag 40 includes a storing unit 41, an antenna 42, a data transmitting and receiving unit 43, and a controlling unit 44.

The storing unit 41 is a memory that stores various kinds of information. Precisely, the storing unit 41 stores ID information 41a, authentication keyhole information 41b, and decoding key information 41c. The ID information 41a is used to identify the RFID tag 40.

The authentication keyhole information 41b is for comparing with the authentication key information that is acquired from the authentication keys 31a and 31b.

The decoding key information 41c is used for decoding the coded authentication key information acquired from the authentication keys 31a and 31b. The authentication key information represented by the authentication keys 31a and 31b is a coded form to prevent third parties from reading with ease the authentication key information.

The information relating to the positions where the authentication keys 31a and 31b are formed on the artificial tooth 30 can be stored in the storing unit 41. This allows the positions of the authentication keys 31a and 31b to be determined with ease.

The antenna 42 allows communication through electromagnetic waves between an authenticating apparatus 50 and the RFIG tag 40. The data transmitting and receiving unit 43 transmits and receives various data, via the antenna 42, between the RFID tag and the authenticating apparatus 50. The controlling unit 44 controls the entire RFID tag 40 and controls, for example, the transmission and reception of data between the functional units in the RFID tag 40.

The authenticating apparatus 50 judges whether the decoded authentication key information coincides with the authentication keyhole information acquired from the authentication RFID tag. When the two coincide with each other, the authenticating apparatus 50 reads the information from the database and outputs the information.

The authenticating apparatus 50 includes an inputting unit 51, a displaying unit 52, an owner information database 53, an authentication key conversion information database 54, an authentication key reading unit 55, an RFID tag information reading unit 56, a decoding processing unit 57, an authentication processing unit 58, and a controlling unit 59.

Examples of the inputting unit 51 include inputting devices such as a keyboard and a mouse. The displaying unit 52 includes a displaying device such as a CRT or LCD. The owner information database 53 correlate information on the owner of the artificial tooth 30 with the ID information 41a of the RFID tag 40 and stores the correlated information on the owner as the information relating to the artificial tooth 30.

More particularly, the owner information database 53 stores information on the material of the artificial tooth 30 and various chemical treatments performed when the artificial tooth 30 is prepared, information on the attachment of the artificial tooth 30, information on the maintenance of the artificial tooth 30, information on the setting of the details of various equipment when therapy is made, information on the process procedure of the disposal of the artificial tooth 30 and so on.

The authentication key conversion information database 54 stores conversion information used for converting the depressions and protrusions of the authentication keys 31a and 31b into characters and numerical symbols. More particularly, the authentication key conversion information database 54 stores information on the assignment of characters and numerical symbols to depressions and protrusions having various sizes and shapes, respectively, one for one.

The authentication key reading unit 55 acquires images of the authentication keys 31a and 31b and converts the depressions and protrusions having various sizes and shapes into characters and numerical symbols, respectively one for one, with referring to the authentication key conversion information database 54.

The authentication key reading unit 55 is attached to, for example, a tip portion of an equipment, which portion is inserted into the mouth of a person. This allows the authentication key reading unit 55 to acquire the images of the authentication keys 31a and 31b with ease.

The RFID tag information reading unit 56 performs electromagnetic wave communication between the RFID tag 40 and the authenticating apparatus 50, and reads the ID information 41a, the authentication keyhole information 41b, and the decoding key information 41c from the RFID tag.

When the authentication key reading unit 55 converts the depressions and protrusions with various sizes and shapes into the coded authentication key information, the decoding processing unit 57 decodes the coded authentication key information based on the decoding key information 41c read from the RFID tag 40.

The authentication processing unit 58 collates the authentication key information decoded by the decoding processing unit 57 with the authentication keyhole information read by the RFID tag information reading unit 56 from the RFID tag 40. When the authentication key information coincides with the authentication keyhole information, the authentication processing unit 58 outputs to the displaying unit 52 the information relating to the artificial tooth 30 stored in the owner information database 53.

The controlling unit 59 controls the entire authenticating apparatus 50 and controls the transmission and reception of data among the various functional units.

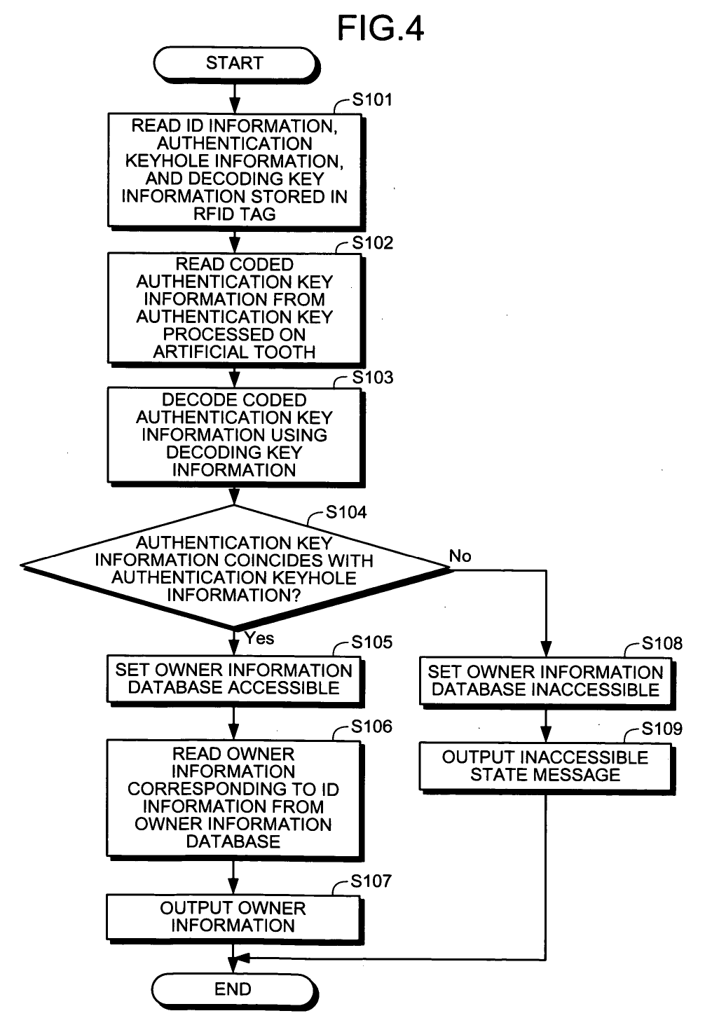

FIG. 4 is a flowchart of the process procedure performed by the authenticating apparatus 50.

The RFID tag information reading unit 56 reads the ID information 41a, the authentication keyhole information 41b, and the decoding key information 41c from the RFID tag 40 (step S101).

The authentication key reading unit 55 reads the coded authentication key information from the authentication keys 31a and 31b processed on the artificial tooth 30 (step S102). Then, the decoding processing unit 57 decodes the coded authentication key information using the decoding key information 41c (step S103).

The authentication processing unit 58 checks whether the decoded authentication key information coincides with the authentication keyhole information 41b (step S104). When the two do not coincide (step S104, NO), the authentication processing unit 58 sets the owner information database 53 inaccessible (step S108).

The authentication processing unit 58 outputs an inaccessible state message, which says that the owner information database 53 has been put into an inaccessible state, to the displaying unit 52 (step S109), and terminates the authentication process.

When the two coincide (step S104, YES), the authentication processing unit 58 sets the owner information database 53 accessible (step S105).

The authentication processing unit 58 reads, from the owner information database 53, the information on the owner that corresponds to the ID information 41a read from the RFID tag 40 (step S106). The authentication processing unit 58 outputs the read owner information to the displaying unit 2 (step S107), and terminates the authentication process.

In the above-mentioned authentication process, the authentication keyhole information 41b is read from the RFID tag 40. However, the authentication process can be performed in a different manner. For example, the authentication keyhole information can be correlated with the ID information 41a of the RFID tag 40 and stored in a database in the authenticating apparatus 50. When the authenticating apparatus 50 authenticates the ID information 41a, the authenticating apparatus 50 reads the authentication keyhole information from the database and judges whether the authentication keyhole information coincides with the authentication key information.

In the above-mentioned authentication process, a photograph of the entirety of the authentication keys 31a and 31b. However, the authentication key information can be read by taking a picture of only a part of from the authentication keys 31a and 31b.

Moreover, an image of each portion of the authentication keys 31a and 31b can be acquired in a predetermined sequence and authentication key information can be read from each partial image to obtain a plurality of pieces of partial authentication key information. The plurality of pieces of the partial authentication key information are combined to generate new authentication key information. Then, judgment can be made whether the generated authentication key information coincides with the authentication keyhole information that is obtained by reconstituting the images in order of their acquisition.

In the first embodiment, the authentication keys 11a and 11b from which the authentication key information relating to authentication to check to see whether the user has authority to make access to the information relating to the artificial tooth 10 are formed by processing the artificial tooth 10. Accordingly, when the information relating to the artificial tooth 10 is read, authentication performed using the authentication keys 11a and 11b can effectively reduce a risk that the information is read by unauthorized persons.

Moreover, the authentication keys 11a and 11b are carved on the surface of the artificial tooth 10. Accordingly, when the information relating to the artificial tooth 10 is read, authentication-performed using the authentication keys 11a and 11b formed by processing the artificial tooth 10 to provide the artificial tooth 10 with depressions and protrusions can effectively reduce the risk that the information is read by unauthorized persons.

Furthermore, the authentication keys 11a and 11b are formed at a plurality of sites. Accordingly, when the authentication key at one of the sites is damaged, authentication can be performed using the authentication key at another site.

Moreover, the authentication key reading unit 55 of the authenticating apparatus 50 reads the authentication key information relating to the authentication whether the user has an authority to make access to the information relating to the artificial tooth 30, and the authentication processing unit 58 performs authentication whether the user has the authority to make access to the information relating to the artificial tooth 30 based on the authentication key information read by the authentication key reading unit 55. Accordingly, when the information relating to the artificial tooth 30 is read, authentication performed using the authentication keys 31a and 31b formed by processing the artificial tooth 30 can effectively reduce the risk that the information is read by unauthorized persons.

Furthermore, the authentication key reading unit 55 reads the authentication key information from a predetermined portions of the authentication keys 31a and 31b, and the authentication processing unit 58 performs authentication whether the user has the authority to make access to the information relating to the artificial tooth 30 based on the authentication key information read by the authentication key reading unit 55. Accordingly, the risk that the information is read by unauthorized persons can reduce effectively by changing the portions of the authentication keys 31a and 31b from which the authentication key information is read to change the authentication key information.

Moreover, the authentication key reading unit 55 reads the authentication key information from each portion of the authentication keys 31a and 31b in the predetermined order, and the authentication processing unit 58 performs authentication whether the user has the authority to make access to the information relating to the artificial tooth 30 based on the authentication key information read by the authentication key reading unit 55. Accordingly, the risk that the information is read by unauthorized persons can reduce effectively by changing the order in which the authentication key information is read from the authentication keys 31a and 31b to change the authentication key information.

Furthermore, the RFID tag information reading unit 56 reads the authentication keyhole information that is to be collated with the authentication key information, and the authentication processing unit 58 performs authentication whether the user has the authority to make access to the information relating to the artificial tooth 30 based on the correspondence between the authentication key information and the authentication keyhole information. Accordingly, the risk that the information is read by unauthorized persons can reduce effectively by collating the authentication key information with the authentication keyhole information.

Moreover, the RFID tag information reading unit 56 reads the authentication keyhole information 41b from the RFID tag 40. Accordingly, the risk that the information is read by unauthorized persons can reduce effectively by reading the authentication keyhole information 41b from the RFID tag 40, which is independent of the artificial tooth 30 on which the authentication keys 31a and 31b are formed and collating the read authentication keyhole information with the authentication key information.

Furthermore, the RFID tag information reading unit 56 reads the ID information 41a from the RFID tag 40, and the authentication processing unit 58 reads the authentication keyhole information from the database that stores the ID information 41a in the RFID tag and the authentication keyhole information in a related manner based on the ID information 41a read by the RFID tag information reading unit 56. Accordingly, the risk that the information is read by unauthorized persons can reduce effectively by reading the authentication keyhole information from the database and collating the authentication keyhole information with the authentication key information.

Furthermore, the article on which the authentication keys 31a and 31b are formed is an article that a person wears, such as the artificial tooth 30. Accordingly, authentication of the person can be performed anywhere.

Moreover, the authentication key reading unit 55 reads the authentication key information by irradiating electromagnetic waves or sonic waves to the authentication keys 31a and 31b. Accordingly, the authentication key information can be read effectively.

Furthermore, the authentication key reading unit 55 reads the authentication key information by acquiring the images of the authentication keys 31a and 31b. Accordingly, the authentication key information can be read effectively.

An authentication system according to a second embodiment is explained below. In the authentication system according to the second embodiment, in contrast to the authentication system according to the first embodiment, a RFID tag transmits information only when the RFID tag receives predetermined information relating to an authentication key from an authenticating apparatus. This configurations prevents an authenticating apparatus of a third party from reading the information.

More particularly, an RFID tag that responds to communication using electromagnetic waves with the authenticating apparatus is attached to an article that is provided with an authentication key. When the article is a thing worn by a person, such as an artificial tooth, communication with strong electromagnetic waves is not preferable. However, when the article is one of precious goods that are detachable, such as a watch and a gem, the intensity of the electromagnetic waves gives no problems.

The authenticating apparatus sends an inquiry to the RFID tag attached to the article. When a response to the inquiry is received from the RFID tag, it is found that the RFID tag is judged to be in a position to make communication with the authenticating apparatus and in a condition that the RFID tag can read the authentication key information from the authentication key. In this manner, whether the reading of the authentication key information is in a standby state is checked.

When the authenticating apparatus detects the response from the RFID tag to the inquiry, the authenticating apparatus transmits response detection information to the RFID tag, which stores various kinds of information, such as authentication keyhole information. The RFID tag transmits information such as the authentication keyhole information only when the RFID tag receives the response detection information from the authenticating apparatus.

With this configuration, when there is no response from the RFID tag attached to the article, the risk that the information such as the authentication keyhole information is read by the third party can reduced effectively.

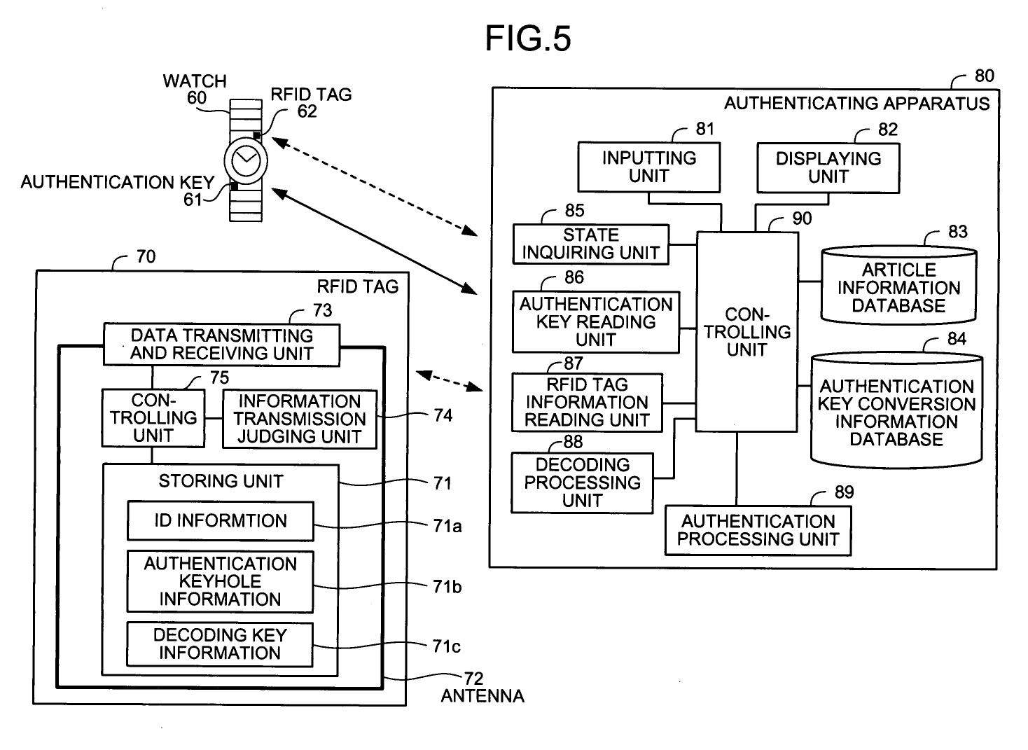

FIG. 5 is a functional block diagram of an authentication system according to the second embodiment. The authentication system includes a watch 60, an RFID tag 70, and an authenticating apparatus 80.

The watch 60 has an authentication key 61 that is formed on the surface thereof and similar to that explained referring to FIG. 1, and an RFID tag 62 that performs communication with electromagnetic waves with the authenticating apparatus 80. The RFID tag 62 transmits response information when the RFID tag 62 receives an inquiry from the authenticating apparatus 80.

The RFID tag 70 is attached to, for example, a plastic card and is substantially the same as that explained referring to FIG. 3. The RFID tag 70, however, is configured to transmit requested information only when the RFID tag 70 receives from the authenticating apparatus 80 an information transmission request that contains response detection information to indicate that a response from the RFID tag 62 attached to the watch 60 is detected.

The RFID tag 70 includes a storing unit 71, an antenna 72, a data transmitting and receiving unit 73, an information transmission judging unit 74 that judges whether information is to be transmitted, and a controlling unit 75. The storing unit 71 stores ID information 71a, authentication keyhole information 71b, and decoding key information 71c.

The storing unit 71, the ID information 71a, the authentication keyhole information 71b, the decoding key information 71c, the antenna 72, the data transmitting and receiving unit 73, and the controlling unit 75 have the same functions as those of the storing unit 41, the ID information 41a, the authentication keyhole information 41b, the decoding key information 41c, the antenna 42, the data transmitting and receiving unit 43, and the controlling unit 44 explained referring to FIG. 3.

The information transmission judging unit 74 checks to see whether the information transmission request that contains the response detection information is received from the authenticating apparatus 80 and when the information transmission request is received, the information transmission judging unit 74 permits transmission of the ID information 71a, the authentication keyhole information 71b, and the decoding key information 71c.

The authenticating apparatus 80 is substantially the same as the authenticating apparatus 50 explained referring to FIG. 3. However, the authenticating apparatus 80 performs communication with the RFID tag 62 attached to the watch 60 and detects a response from the RFID tag 62.

When the authenticating apparatus 80 detects a response from the RFID tag 62, the authenticating apparatus 80 transmits information transmission request that contains response detection information indicating that the response is detected to the RFID tag 70, and receives the ID information 71a, the authentication keyhole information 71b, and the decoding key information 71c transmitted by the RFID tag 70.

The authenticating apparatus 80 includes an inputting unit 81, a displaying unit 82, an article information database 83, an authentication key conversion information database 84, a state inquiring unit 85, an authentication key reading unit 86, an RFID tag information reading unit 87, a decoding processing unit 88, an authentication processing unit 89, and a controlling unit 90.

The inputting unit 81, the displaying unit 82, the authentication key conversion information database 84, the authentication key reading unit 86, the decoding processing unit 88, the authentication processing unit 89, and the controlling unit 90 have the same functions as those of the inputting unit 51, the displaying unit 52, the authentication key conversion information database 54, the authentication key reading unit 55, the decoding processing unit 57, the authentication processing unit 58, and the controlling unit 59, respectively.

The article information database 83 stores information relating to the watch 60, such as history of repairing the watch 60 and information of the owner of the watch. The authentication process according to this embodiment is performed when the data stored in the article information database 83 is read.

The state inquiring unit 85 makes an inquiry to the RFID tag 62 attached to the watch 60 and detects a response to the inquiry transmitted by the RFID tag 62.

When the state inquiring unit 85 detects the response from the RFID tag 62, the RFID tag information reading unit 87 transmits the information transmission request that contains the response detection information to the RFID tag 70 and receives the ID information 71a, authentication keyhole information 71b, and the decoding key information 71c transmitted by the RFID tag 70 in response to the information transmission request.

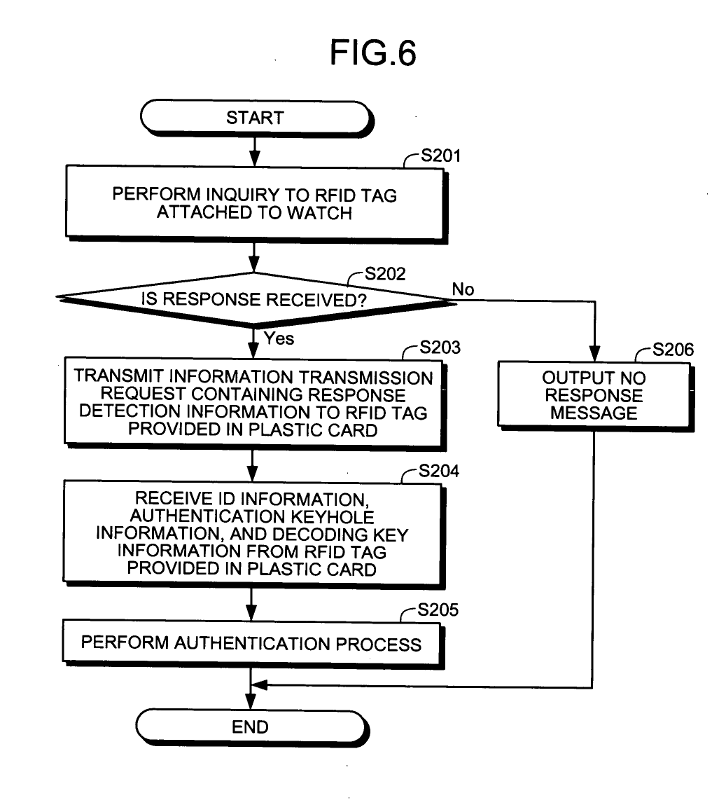

FIG. 6 is a flowchart of a process procedure of authentication according to the second embodiment. The state inquiring unit 85 performs inquiry to the RFID tag 62 attached to the watch 60 (step S201).

The state inquiring unit 85 checks to see whether a response is received from the RFID tag 62 (step S202). When no response is received (step S202, NO), the state inquiring unit 85 outputs to the displaying unit 82 a no response message that indicates that no response is received (step S206), and the authentication unit 89 terminates the authentication process.

When a response from the RFID tag 62 is received (step S202, YES), the RFID tag information reading unit 87 transmits the information transmission request containing the response detection information to the RFID tag 70 provided in the plastic card (step S206).

The RFID tag information reading unit 87 receives the ID information 71a, authentication keyhole information 71b, and the decoding key information 71c transmitted by the RFID tag 70 in response to the information transmission request (step S204).

The authentication key reading unit 86, the decoding processing unit 88, and the authentication processing unit 89 performs an authentication process similar to that explained referring to FIG. 4 (step S205), and the authentication unit 89 terminates the authentication process.

In the second embodiment, when the state inquiring unit 85 receives the response to the inquiry from the RFID tag 62 attached to the watch 60 on which the authentication key 61 is formed, the state inquiring unit 85 reads the authentication keyhole information 71b from the RFID tag 70, which is readable only when a response is received. Accordingly, the risk that the information is read by unauthorized persons can reduce effectively by restricting the access to the authentication keyhole information 71b.

An authentication system according to a third embodiment is explained. While in the first and second embodiments the information relating to the article on which the authentication key is formed is read using the authentication key, a further examination is performed in the third embodiment when a plurality of articles are involved to check whether all the articles are present.

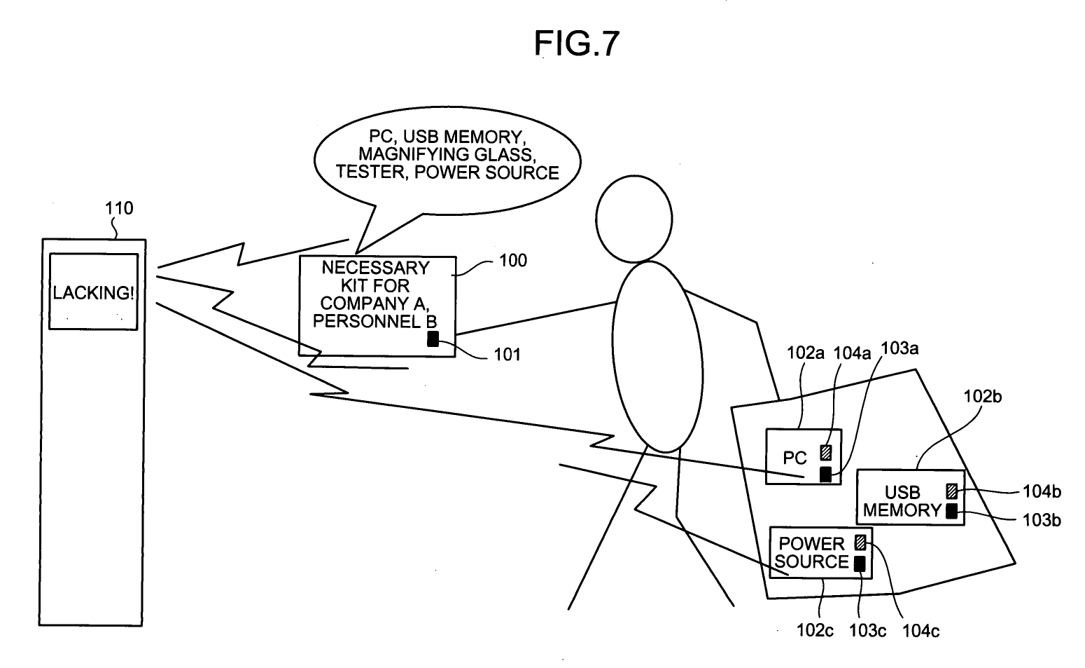

FIG. 7 is a schematic for explaining an idea of lacking article detection to determine whether any article is lacking. Suppose a personnel B of a company A carries an integrated circuit (IC) card 100 in which an RFID tag 101 is incorporated. The IC card 100 carries information on a kit that the personnel B needs when he goes out. The kit can include, for example, a personal computer (PC) 102a, a universal serial bus (USB) memory 102b, a power source 102c, a magnifying glass, and a tester. In this lacking article detection process, information on various articles, for example, the PC 102a, the USB memory 102b, and the power source 102c that are to be carried on when the user goes out is stored in the RFID tag 101.

An authenticating apparatus 110 placed in, for example, the entrance of the house communicates with the RFID tag 101 and reads the information on the the PC 102a, the USB memory 102b, and the power source 102c to be carried on by the user when the user goes out.

The authenticating apparatus 110 communicates with RFID tag 103a to 103c attached to the PC 102a, the USB memory 102b, and the power source 102c, respectively, and reads the respective pieces of the ID information from the RFID tag 103a to 103c.

The authenticating apparatus 110 judges whether all of the PC 102a, the USB memory 102b, and the power source 102c are present based on the information on the articles 102a to 102c to be carried on that is read from the RFID tag 101 and the ID information from the RFID tags 103a to 103c. When not all the articles are present, the authenticating apparatus 110 outputs a message indicating that some or all of the PC 102a, the USB memory 102b, and the power source 102c are absent.

The authenticating apparatus 110 performs authentication using authentication keys 104a to 104c formed on the PC 102a, the USB memory 102b, and the power source 102c, respectively, when the authenticating apparatus receives a request for outputting detailed information relating to the PC 102a, the USB memory 102b, and the power source 102c from the user who carries the PC 102a, the USB memory 102b, and the power source 102c, and outputs the detailed information on the PC 102a, the USB memory 102b, and the power source 102c only when the authentication was successful.

This makes it easy to confirm whether some or all of the PC 102a, the USB memory 102b, and the power source 102c are absent and enables reading the information on the PC 102a, the USB memory 102b, and the power source 102c without the risk of being read by unauthorized persons.

While the authenticating apparatus detects whether some or all of the PC 102a, the USB memory 102b, and the power source 102c are absent, the authenticating apparatus may, when unnecessary articles are involved, detect whether some or all of the PC 102a, the USB memory 102b, and the power source 102c are unnecessary.

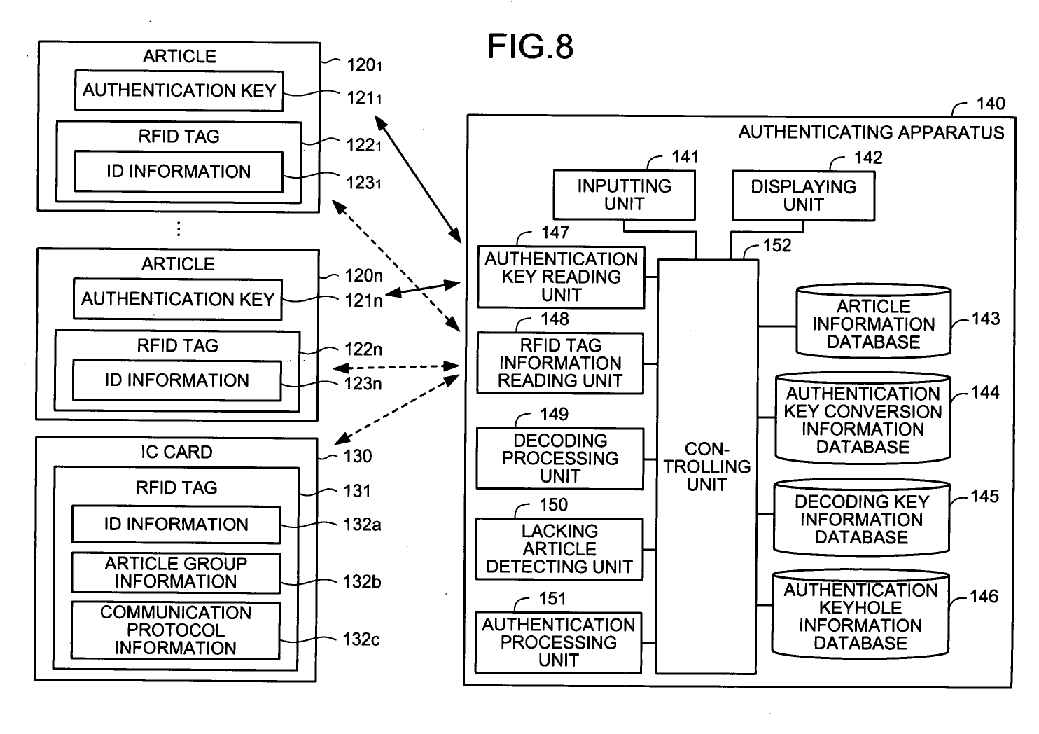

The functional configuration of the authentication system in this embodiment is explained. FIG. 8 is a functional block diagram of an authentication system according to this embodiment. The authentication system includes articles 120₁ to 120ₙ, an IC card 130, and an authenticating apparatus 140.

The articles 120₁ to 120ₙ, the IC card 130, and the authenticating apparatus 140 correspond to the PC 102a, the USB memory 102b, and the power source 102c, the IC card 100, and the authenticating apparatus 110, respectively, that are explained referring to FIG. 7 although the number of members involved may be different. When n is three, the number of the members also correspond to each other.

The articles 120₁ to 120ₙ, have formed thereon authentication keys 121₁ to 121ₙ, respectively, and have attached thereto RFID tags 122₁ to 122ₙ, respectively, that store a plurality of pieces of ID information 123₁ to 123ₙ.

The RFID tags 122₁ to 122ₙ have configurations similar to that of the RFID tag 40 and include functional units corresponding to the storing unit 41, the antenna 42, the data transmitting and receiving unit 43, and the controlling unit 44, which are not shown in FIG. 8.

The pieces of the ID information 123₁ to 123ₙ are similar to the ID information 41a explained referring to FIG. 3 and relate to ID numbers that are intended to recognize the respective RFID tags 122₁ to 122ₙ.

The IC card 130 is a plastic card that has incorporated therein an RFID tag 131. The RFID tag 131 stores ID information 132a, article group information 132b, and communication protocol information 133c.

The RFID tag 131 have configurations similar to that of the RFID tag 40 explained referring to FIG. 3, and includes functional groups that correspond to the storing unit 41, the antenna 42, the data transmitting and receiving unit 43, and the controlling unit 44, which are not shown in FIG. 8.

The ID information 132a is an ID number that identifies the RFID tag 131 attached to the IC card 130. The article group information 132b relates to the pieces of the ID information 123₁ to 123ₙ on the articles 120₁ to 120ₙ to be carried by the user when the user goes out.

Communication protocol information 132c relates to information on the communication protocols used when the authenticating apparatus 140 communicates with the RFID tags 122₁ to 122ₙ. The communication protocols differ for different members of the RFID tags 122₁ to 122ₙ.

The authenticating apparatus 140 acquires the information on the articles 120₁ to 120ₙ from the IC card 130, and communicates with the RFID tags 122₁ to 122ₙ to judge whether all the articles 120₁ to 120ₙ to be carried on when the user goes out are present.

When the authenticating apparatus 140 receives a request for outputting detailed information relating to the articles 120₁ to 120ₙ from the user who carries the articles 120₁ to 120ₙ, the authenticating apparatus 140 performs an authentication process using the authentication keys 121₁ to 121ₙ in the same manner as explained in the first and the second embodiments. When the authentication was successful, the authenticating apparatus 140 outputs detailed information on the articles 120₁ to 120ₙ.

The authenticating apparatus 140 includes an inputting unit 141, a displaying unit 142, an article information database 143, an authentication key conversion information database 144, a decoding key information database 145, an authentication keyhole information database 146, an authentication key reading unit 147, an RFID tag information reading unit 148, a decoding processing unit 149, a lacking article detecting unit 150, an authentication processing unit 151, and a controlling unit 152.

The inputting unit 141 is an inputting device such as a keyboard or a mouse. The displaying unit 142 is a displaying device such as a display. The article information database 143 correlates detailed information on the articles 120₁ to 120ₙ with the pieces of the ID information 123₁ to 123ₙ of the RFID tags 122₁ to 122ₙ and stores the correlated detailed information.

The authentication key conversion information database 144 is similar to the authentication key conversion information database 54 explained referring to FIG. 3, and stores a conversion table that is used to convert the depressions and protrusions of the authentication keys 121₁ to 121ₙ having various sizes and shapes into characters and numerical symbols.

The decoding key information database 145 stores information similar to the decoding key information 41c explained referring to FIG. 3. The decoding key information database 145 correlates keys used for decoding the coded authentication key information with the pieces of the ID information 123₁ to 123ₙ and stores the correlated key information.

The authentication keyhole information database 146 stores information similar to the authentication keyhole information 41b explained referring to FIG. 3. The authentication keyhole information database 146 correlates the keyhole information to be collated with the authentication key information acquired based on the authentication keys 121₁ to 121ₙ with the pieces of the ID information 123₁ to 123ₙ and stores the correlated authentication keyhole information.

When the authentication key reading unit 147 receives a request for outputting detailed information on the articles 120₁ to 120ₙ from the user who carries the articles 120₁ to 120ₙ, the authentication key reading unit 147 takes a picture of the authentication keys 121₁ to 121ₙ having depressions and protrusions formed on the articles 120₁ to 120ₙ, respectively, and converts the depressions and protrusions into characters and numerical symbols with consulting the authentication key conversion information database 144. The characters and the numerical symbols read by the authentication key reading unit 147 are coded.

The RFID tag information reading unit 148 performs communication with electromagnetic waves with the RFID tag 131 incorporated in the IC card 130, and reads the ID information 132a, the article group information 132b, and the communication protocol information 132c.

The RFID tag information reading unit 148 performs communication with electromagnetic waves with the RFID tags 122₁ to 122ₙ attached to the articles 120₁ to 120ₙ based on the communication protocol information 132c read from the RFID tag 131 incorporated in the IC card 130.

The decoding processing unit 149 is similar to the decoding processing unit 57 explained referring to FIG. 3. When the authentication key reading unit 147 converts the depressions and protrusions into coded characters and numerical symbols, the decoding processing unit 149 reads a decoding key from the decoding key information database 145, and decodes the coded characters and numerical symbols using the read decoding key to generate an authentication key information.

The lacking article detecting unit 150 judges whether all the articles 120₁ to 120ₙ to be carried on when the user goes out are present based on the article group information 132b acquired from the IC card 130 and the pieces of the ID information 123₁ to 123ₙ acquired from the RFID tags 122₁ to 122ₙ attached to the articles 120₁ to 120ₙ.

When the lacking article detecting unit 150 judged that not all the articles 120₁ to 120ₙ to be carried on when the user goes out are present, the lacking article detecting unit 150 outputs a message indicating that some or all of the articles 120₁ to 120ₙ are absent.

When the lacking article detecting unit 150 judged that all the articles 120₁ to 120ₙ to be carried on when the user goes out are present, the lacking article detecting unit 150 outputs a message indicating that all the articles 120₁ to 120ₙ are present.

The authentication processing unit 151 collates the authentication key information generated by the decoding processing unit 149 with the authentication keyhole information read from the authentication keyhole information database 146. When the authentication key information coincided with the authentication keyhole information, the authentication processing unit 151 outputs the detailed information on the articles 120₁ to 120ₙ stored in the article information database 143 to the displaying unit 142.

The controlling unit 152 controls the entire authenticating apparatus 140 and controls transmission and reception of the data between the various functional units.

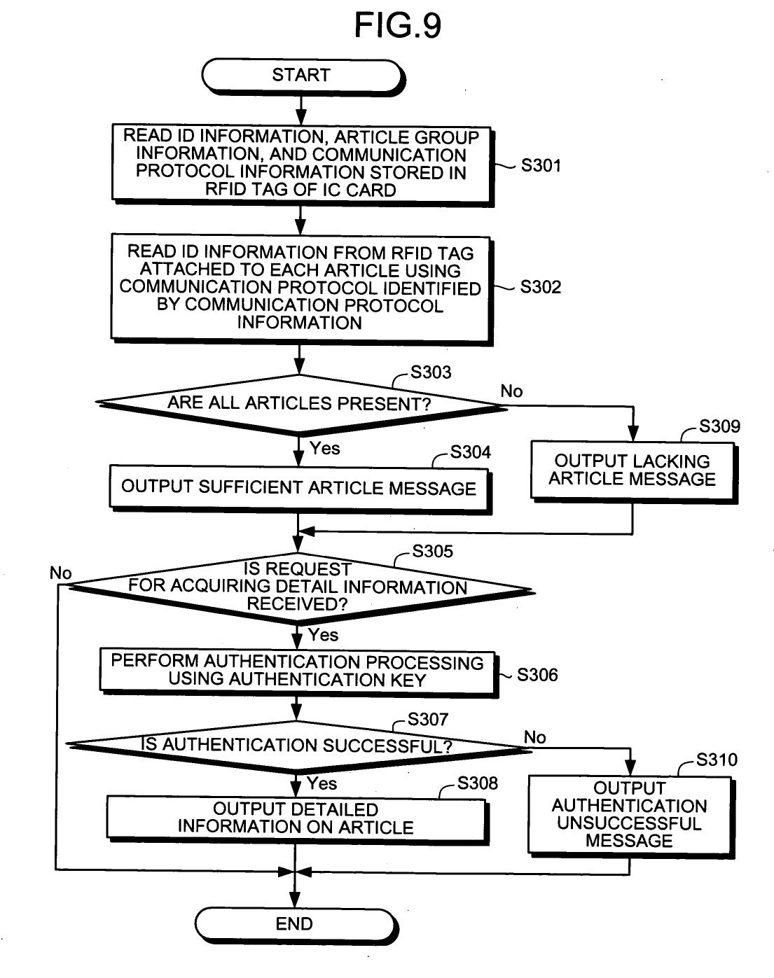

FIG. 9 is a flowchart of the process procedure of authentication according to the third embodiment.

The RFID tag information reading unit 148 in the authenticating apparatus 140 reads the ID information 132a, the article group information 132b, and the communication protocol information 132c stored in the RFID tag 131 of the IC card 130 (step S301).

The RFID tag information reading unit 148 reads the pieces of the ID information 123₁ to 123ₙ from the RFID tags 122₁ to 122ₙ attached to the articles 120₁ to 120ₙ, respectively, using the communication protocol identified by the communication protocol information 132c (step S302).

The lacking article detecting unit 150 checks to see whether all the articles 120₁ to 120ₙ to be carried on when the user goes out are present based on the article group information 132b and the pieces of the ID information 123₁ to 123ₙ acquired from the RFID tags 122₁ to 122ₙ, respectively (step S303).

When all the articles 120₁ to 120ₙ are present (step S303, YES), the lacking article detecting unit 150 outputs a sufficient article message indicating that all the articles 120₁ to 120ₙ are present (step S304).

When not all the articles 120₁ to 120ₙ are present (step S303, NO), the lacking article detecting unit 150 outputs a lacking article message (step S309).

After the steps S304 and S309, the authentication key reading unit 147 checks to see whether a request for acquiring detail information on the articles 120₁ to 120ₙ is received (step S305). When no request for acquiring detailed information on the articles 120₁ to 120ₙ was received (step S305, NO), the authentication process is terminated.

When the request for acquiring the detailed information on the articles 120₁ to 120ₙ was received (step S305, YES), the authentication key reading unit 147, the decoding processing unit 149, and the authentication processing unit 151 performs an authentication process using the authentication keys 121₁ to 121ₙ in the same manner as that explained referring to FIG. 4 (step S306).

The authentication processing unit 151 checks whether the authentication was successful (step S307). When the authentication was successful (step S307, YES), the authentication processing unit 151 reads the detailed information on the articles 120₁ to 120ₙ from the article information database 143 and outputs the read detailed information to the displaying unit 142 (step S308) to terminate the authentication process.

When the authentication was unsuccessful (step S307, NO), the authentication processing unit 151 outputs an authentication unsuccessful message indicating that the authentication was unsuccessful (step S310) to terminate the authentication process.

In the third embodiment, the RFID tag information reading unit 148 reads the pieces of the ID information 123₁ to 123ₙ of the articles 120₁ to 120ₙ to which a plurality of RFID tags 122₁ to 122ₙ are attached from the RFID tags 122₁ to 122ₙ and the article group information 132b from the RFID tag 131 attached to the IC card 130, the lacking article detecting unit 150 judges whether all the articles 120₁ to 120ₙ are present based on the pieces of the ID information 123₁ to 123ₙ and the article group information 132b, the authentication key reading unit 147 reads the authentication key from the authentication keys 121₁ to 121ₙ formed on the articles 120₁ to 120ₙ when the authentication key reading unit 147 received a request for making access to the information relating to the articles 120₁ to 120₁, and the authentication processing unit 151 performs authentication whether the user has authority to make access to the information relating to the articles 120₁ to 120ₙ based on the authentication key information read by the authentication key reading unit 147. Accordingly, the risk that the information is read by unauthorized persons can reduce effectively and whether all the articles 120₁ to 120ₙ are present can be checked.

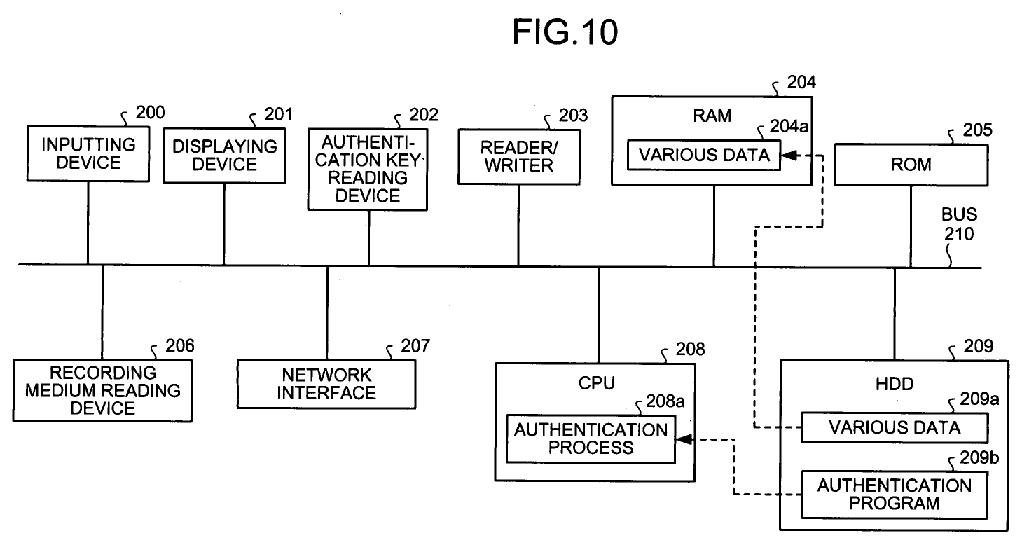

The various processes explained in the above-mentioned embodiments can be realized by executing a computer program provided in advance on a computer. Referring to FIG. 10, an example of the computer that executes the computer program that realizes the various processes is explained. FIG. 10 is a block diagram of a hardware construction of a computer that serves as an authenticating apparatus in the authentication system shown in FIG. 3, 5 or 8.

The computer includes an inputting device 200 that accepts data input by the user, a displaying device 201, an authentication key reading device 202, a reader/writer 203 that performs radio frequency (RF) communication with the RFID tag and stores the information in and reads the information from the RFID tag, a random access memory (RAM) 204, a read only memory (ROM) 205, a recording medium reading device 206 that reads a computer program from a recording medium that stores various computer programs, a network interface 207 that transmits and receives data to and from other computers via the network a central processing unit (CPU) 208, a hard disk drive (HDD) 209, and a bus 210 that connects thereto the inputting device 200, the displaying device 201, the authentication key reading device 202, the reader/writer 203, the RAM 204, the ROM 205, the recording medium reading device 206, the network interface 207, and the CPU 208, the HDD 209.

The HDD 209 stores a computer program that realizes the same functions as those of the authenticating apparatuses 50, 80, and 140, that is, an authentication program 209b shown in FIG. 10. The authentication program 209b may be stored in a dispersed manner.

The CPU 208 reads the authentication program 209b from the HDD 209 and executes the authentication program 209b to realize an authentication process 208a. The authentication process 208a corresponds to the processing processes of the functional units shown in FIGS. 3, 5 and 8.

The HDD 290 stores various data 209a. The data 209a correspond to the data stored in the owner information database 53, the authentication key conversion information database 54, the article information database 83, the authentication key conversion information database 84, the article information database 143, the authentication key conversion information database 144, the decoding key information database 145, and the authentication keyhole information database 146 and so on shown in FIGS. 3, 5, or 8.

The CPU 208 stores the various data 209a in the HDD 209, reads the various data 209a from the HDD 209, stores the data in the RAM 204, and performs the authentication process based on the various data 204a stored in the RAM 204.

The authentication program 209b need not be stored in the HDD 209 from the beginning. Each computer program may be stored, for example, in a “portable physical medium” such as a flexible disk (FD), a compact disk read only memory (CD-ROM), a magnetooptic (MO) disk, or an integrated circuit (IC) card, or in a “physical medium to be fixed” such as an HDD disk that is provided inside-or outside the computer, as well as “other computer (or server)” that is connected to the computer via public communication line, the Internet, a local area network (LAN), or a wide area network (WAN) and the computer may read the program from the recording medium and execute the program.

All or a part of the above-mentioned processes that have been explained as being performed automatically may be performed manually, or all or a part of the above-mentioned processes that have been explained as being performed manually may be performed automatically by known methods.

The process procedures, control procedures, specific names, information containing various data and parameters may be changed arbitrarily unless otherwise indicated specifically.

The elements of the various devices are functionally explained and need not be configured physically exactly as shown in the drawings. That is, specific modes of dispersion and integration of the devices is not limited to that depicted in the drawings and all or a part of the elements may be functionally or physically dispersed or integrated in any desired units.

The processing functions performed in the various devices are entirely or partly realized by the computer CPU and the program analyzed and executed by the CPU or realized as hardware operated with on wired logics.

According to the present invention, an authentication key is formed by processing an article worn by a living being. Therefore, it is possible to reduce the risk that the authentication key is read by unauthorized persons.

Moreover, the authentication key is formed on the article by carving the surface of the article. Therefore, it is difficult to falsify the authentication key.

Furthermore, the authentication keys are formed in plurality. Therefore, other authentication key can be used if one authentication key is damaged, thereby increasing the reliability.

According to the present invention, the authentication information relating to the authentication whether an authority to make access to the information relating to the article is read from the authentication key formed by processing the article itself and the authentication whether an authority to make access to the information relating to the article is present is performed. Accordingly, the present invention has the effect that the risk that the information is read by unauthorized persons can reduce effectively by performing the authentication using the authentication key formed by processing the article itself.

According to the present invention, the authentication key information is read from a predetermined portion of the authentication key, and the authentication whether an authority to make access to the information relating to the article is present is performed. Therefore, the invention has the effect that that the risk that the information is read by unauthorized persons can reduce effectively by changing the portion form which the authentication key is read to change the authentication key.

According to the present invention, the authentication key information is read from the respective portions of the authentication key in a predetermined order and the authentication whether an authority to make access to the information to the article is present is performed based on the read authentication information. Therefore, the present invention has the effect that the risk that the information is read by unauthorized persons can reduce effectively by changing the order in which the authentication information is read from the respective portions of the authentication key to change the authentication key information.

According to the present invention, the authentication is the authentication keyhole information to be collated with the authentication key information is read and the authentication whether an authority to make access to the information to the article is present is performed based on the correspondence between the authentication key information and the authentication keyhole information. Therefore, the present invention has the effect that the risk that the information is read by unauthorized persons can reduce effectively by collating the authentication key information with the authentication keyhole information.

According to the present invention, when the predetermined information is received from the communicating device attached to the article to which the authentication key is formed, the authentication keyhole information that is readable only when the predetermined information is received is read. Therefore, the present invention has the effect that the risk that the information is read by unauthorized persons can reduce effectively by restricting the reading of the authentication keyhole information.

According to the present invention, the authentication keyhole information is read from the RFID tag that stores the authentication keyhole information. Therefore, the present invention has the effect that the risk that the information is read by unauthorized persons can reduce effectively by reading the authentication keyhole information from the RFID tag that is independent of the articles on which the authentication key is formed and collating the authentication key information with the authentication keyhole information.

According to the present invention, the RFID tag identifying information is read from the RFID tag and the authentication keyhole information is read from the database that stores the RFID tag identifying information and the authentication keyhole information in a related manner based on the read identifying information. Therefore, the present invention has the effect that the risk that the information is read by unauthorized persons can reduce effectively by reading the authentication keyhole information and collating the authentication key information with the read authentication keyhole information.

According to the present invention, the identifying information of the articles to which a plurality of the RFID tags are attached is read from the RFID tags, and the information relating to the group of the articles is read from the RFID tags, and the state whether all the articles are present is judged based on the identifying information of the articles and the information on the group of the articles, and when the request for access to the information relating to the articles is received, the authentication key information is read from the authentication key formed on the articles themselves and the authentication whether an authority to make access is present is performed based on the information relating to the articles. Therefore, the present invention has the effect that the risk that the information is read by unauthorized persons can reduce effectively and whether all the articles are present can be checked.

According to the present invention, the article is one that is worn by a person. Therefore, the present invention has the effect that, the reading of the authentication key information can be performed anywhere.

According to the present invention, the reading of the authentication key information is preformed by irradiating the electromagnetic waves or sonic waves. Accordingly, the present invention has the effect that the reading of the authentication can be performed efficiently.

According to the present invention, the reading of the authentication key information is performed by acquiring the image of the authentication key. Therefore, the present invention has the effect that the reading of the authentication can be performed efficiently.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

1. An article that is worn or carried by a living being, comprising:
an authentication key for identifying the living being or acquiring information about the living being, wherein the authentication key is formed on a surface of the article by processing the article.

2. The article according to claim 1, wherein the authentication key includes a pattern that includes depressions and protrusions.

3. The article according to claim 1, comprising a plurality of the authentication keys.

4. The article according to claim 1, wherein the living being is a human being.

5. The article according to claim 1, wherein the living being is an animal.

6. An authenticating apparatus for performing authentication whether an authority to make access to information is present, the authenticating apparatus comprising:
an authentication key information reading unit that reads authentication key information stored in an authentication key, wherein the authentication key is formed on a surface of an article worn or carried by a living being by processing the article and contains information for identifying the living being or information about the living being, and wherein the authentication key information indicates whether an authority to make access to the information about the living being is present; and
an authenticating unit that performs authentication whether an authority to make access to the information about the living being contained in the information key is present based on the authentication key information read by the authentication key information reading unit.

7. The authenticating apparatus according to claim 6, wherein the authentication key information reading unit reads the authentication key information from a predetermined portion of the authentication key.

8. The authenticating apparatus according to claim 6, wherein the authentication key information reading unit reads the authentication key information from each portion of the authentication key in a predetermined order.

9. The authenticating apparatus according to claim 6, further comprising:
an authentication keyhole information reading unit that reads authentication keyhole information that is collated with the authentication key information, wherein
the authenticating unit performs the authentication based on a correspondence between the authentication key information and the authentication keyhole information.

10. The authentication apparatus according to claim 9, wherein when the authentication keyhole information reading unit receives predetermined information from a communication device attached to the article, the authentication keyhole information reading unit reads the authentication keyhole information that is readable only when the predetermined information is received.

11. The authenticating apparatus according to claim 9, wherein the authentication keyhole information reading unit reads the authentication keyhole information from an RFID tag that stores the authentication keyhole information.

12. The authenticating apparatus according to claim 9, further comprising:
a database that stores an RFID tag identifying information and the authentication keyhole information in a related manner; and
an identifying information reading unit that reads the RFID tag identifying information, wherein
the authentication keyhole information reading unit reads the authentication keyhole information from the database based on the RFID tag identifying information.

13. The authenticating apparatus according to claim 6, further comprising:
an article identifying information reading unit that reads, from a plurality of RFID tags, information for identifying the articles to which the RFID tags are attached;
a group information reading unit that reads information about a group of the articles from the RFID tags; and
a state judging unit that judges whether all the articles are present based on the article identifying information and the information about the group of the articles, wherein
the authentication key information reading unit reads the authentication key information from the authentication key when the authentication key information reading unit receives a request to make access to the information about the articles.

14. The authenticating apparatus according to claim 6, wherein the article is one that is worn by a human being.

15. The authenticating apparatus according to claim 6, wherein the article is one that is worn by an animal.

16. The authenticating apparatus according to claim 6, wherein the authentication key information reading unit performs the reading of the authentication key information by irradiating electromagnetic waves or sonic waves to the authentication key.

17. The authenticating apparatus according to claim 6, wherein the authentication key information reading unit performs the reading of the authentication key information by acquiring an image of the authentication key.

18. A method of performing authentication whether an authority to make access to information is present, the method comprising:
reading authentication key information stored in an authentication key, wherein the authentication key is formed on a surface of an article worn or carried by a living being by processing the article and contains information for identifying the living being or information about the living being, and wherein the authentication key information indicates whether an authority to make access to the information about the living being is present; and
performing authentication to check whether an authority to make access to the information about the living being contained in the information key is present based on the read authentication key information.

19. A computer-readable recording medium having recorded therein program for causing a computer to execute a method of performing authentication whether an authority to make access to information is present, the method comprising:
reading authentication key information stored in an authentication key, wherein the authentication key is formed on a surface of an article worn or carried by a living being by processing the article and contains information for identifying the living being or information about the living being, and wherein the authentication key information indicates whether an authority to make access to the information about the living being is present; and
performing authentication to check whether an authority to make access to the information about the living being contained in the information key is present based on the read authentication key information.
